(19) United States
(12) Patent Application Publication
(10) Pub. No.: US 2012/0010920 A1
(43) Pub. Date: Jan. 12, 2012

(54) Method, Apparatus and System for Visualizing User's Web Page Browsing Behavior

(75) Inventor: Huai-Bin Yuan, Hangzhou (CN)

(73) Assignee: ALIBABA GROUP HOLDING LIMITED, Grand Cayman (unknown)

(21) Appl. No.: 12/679,456

(22) PCT Filed: Mar. 5, 2010
(86) PCT No.: PCT/US10/26298

§ 371 Date: Mar. 22, 2010

(30) Foreign Application Priority Data
Mar. 5, 2009 (CN) 200910118399.2

(51) Int. Cl. G06Q 30/00

(52) U.S. Cl. 705/7.29

(57) ABSTRACT

A visual technique for tracking user's webpage browsing behavior is provided. In one aspect, a method includes: gathering data related to the user's mouse clicks; determining a respective number of times the user accessed each section of a plurality of sections of a webpage based on the gathered data; matching each section of the webpage with the respective number of times to establish correlations; and displaying the correlations. A visual mechanism and system for monitoring how users browse the webpage are also described. The disclosed technique will help determine the amount of time and attention a user spends on a particular webpage, and how these correspond to the content of the site. As a result, the user's level of attention to the webpage can be clearly displayed.

### CROSS REFERENCE TO RELATED PATENT APPLICATIONS

This application is a national stage application of an international patent application PCT/US10/26298, filed Mar. 5, 2010, entitled “Method, Apparatus and System for Visualizing User's Web Page Browsing Behavior”, which claims priority from Chinese Patent Application No. 200910118399.2, filed Mar. 5, 2009, entitled “Method, Apparatus and System for Visualizing User's Web Page Browsing Behavior,” which applications are hereby incorporated in their entirety by reference.

### TECHNICAL FIELD

This patent application covers the area of computer internet technology, specifically on the visual mechanism and system for monitoring user's webpage browsing behavior.

### BACKGROUND

A company website is an important platform for promoting and presenting the company's products, and/or conducting online business. The reality is a majority of businesses don't have a direct and clear knowledge of the results of this platform, and even less knowledge of the level of attention that their products receive. If this situation continues, the strategic planners of the company will not have enough supporting figures when deciding marketing and promotional strategies to use, thus lowering the strategy's accuracy, relevancy, and other factors.

Currently, there are many ways to compute the level of attention that a company website receives. For example, these include: analyzing the website's daily log and then performing a collective analysis, or using a third-party software to do the statistics, or even embedding tracking codes in the webpage to compute and analyze data. However, these methods only provide results that focus on the whole website or the individual web pages, not on a particular section of the webpage such as analysis of which products are receiving a lot of attention and which are not. Therefore, these techniques only give inflexible data.

The existing methods have obvious disadvantages: they are indirect, ambiguous, and they expect much from the person reading the report. In addition, as the data from the report has been taken out of context of the products' display platform, there thus lacks a connection between the level of attention that the products receive and the products' display platform. This tends to result in discrepancies and errors in product strategies.

### SUMMARY OF THE DISCLOSURE

The present disclosure introduces a visual technique for tracking user's webpage browsing behavior. In one aspect, a method includes: gathering data related to the user's mouse clicks; determining a respective number of times the user accessed each section of a plurality of sections of a webpage based on the gathered data; matching each section of the webpage with the respective number of times to establish correlations; and displaying the correlations. A visual mechanism and system for monitoring how users browse the webpage are also described. The disclosed technique will help determine the amount of time and attention a user spends on a particular webpage, and how these correspond to the content of the site. As a result, the user's level of attention to the webpage can be clearly displayed.

### DESCRIPTION OF DRAWINGS

FIG. 1 illustrates a process flow diagram of the visual method for monitoring user's webpage browsing behavior according to the present disclosure.

FIG. 2 illustrates a schematic diagram of analyzing data from mouse clicks and the process of constructing a model according to the present disclosure.

FIG. 3 illustrates a schematic diagram of the structure of the mechanism used to monitor the user's webpage browsing behavior according to the present disclosure.

FIG. 4 illustrates a schematic diagram of the structure of the computation module according to the present disclosure.

FIG. 5 illustrates a schematic diagram of the system architecture used to monitor the user's webpage browsing behavior according to the present disclosure.

FIG. 6 illustrates a process flow diagram for monitoring the level of attention that products receive in a company website according to the present disclosure.

FIG. 7 illustrates a resulting ‘hotspot diagram indicating the products’ level of attention according to the present disclosure.

### DETAILED DESCRIPTION

This present disclosure describes a visual technique for monitoring the user's webpage browsing behavior to display the user's level of attention to the webpage content in relation to the other contents of the webpage. It will directly and unambiguously display the user's level of attention to the webpage contents.

In one aspect, a method includes:

Gathering data based on user mouse clicks;

Compute how many times the user accessed a sections on the webpage;

Match with sites/sections that are similar or related;

Display match results

Before gathering the data based on user mouse clicks, the method includes:

Embedded javascript codes in the webpage; when the user clicks onMouseDown, the system will run the additional script in the onMouseDown event to determine the data the user clicks, and then it will transmit this information through httpRequest.

Based on the data gathered, this method will compute how many times the user accessed a link/area on the webpage. It includes:

Acquiring the gathered data based on user mouse clicks, then performing a collective analysis. Using the position clicked as a parameter, it will create a dataset for each section, which includes the number of times the user accessed each section.

The method will perform a collective analysis based on the data gathered through the user mouse clicks. It includes:

If, through the user's IP address, cookie, and position clicks, the system is able to ascertain that the user has repeatedly clicked on a section in the webpage, it will only record in the dataset the first access to the links.

The method will use the position clicked as a parameter, then create a dataset for each section. The following are the steps:

It will generate a blank image, then go back to the original mouse click position, and match it in the blank page;

During the matching process, it will use a predefined component to create a resulting image to mark the user's every mouse click, until it has finished constructing a model for every section's dataset. Then using the generated blank image as the base, it will construct a model diagram of the data pertaining to mouse clicks.

The method will get the frequently accessed sections in a webpage, then match them with sites/sections that are similar or related. Action taken:

It will transform the format of the model image, then based on the difference in the number of times the user clicks each section of the webpage, it will divide the model image into different-colored sections.

After the model image has been transformed, the next step is to turn it into a transparent image.

The method will display the matching results. It will add javascript in the webpage, then through the new layer, download the transparent image, and display it on top of the webpage.

In one aspect, a mechanism includes:

A computation module, which is used to compute the number of times the user accessed each section of the webpage, based on user mouse clicks. The sections are divided according to the contents of the webpage;

A matching module, used to match the sections frequently accessed by the user on the webpage, with sites/sections that are similar or related;

A display module, used to display the match results.

The computed model piece includes the following:

A acquisition unit, in order to get the user mouse click data;

A calculation unit, used to perform collective analysis of user mouse click data. Using the position clicked as a parameter, it will create a dataset for each section, which includes the number of times the user accessed each section.

The calculation unit is used in the following:

If, through the user's IP address, cookie, and position clicks, the system is able to ascertain that the user has repeatedly clicked on a section in the webpage, it will only record in the dataset the first access to the links.

The calculation unit is also used to:

Generate a blank image, then go back to the original mouse click position, and match it in the blank page;

During the matching process, it will use a predefined component to create a resulting image to mark the user's every mouse click action, until it has finished constructing a model for every section's dataset. Then using the generated blank image as the base, it will construct a model diagram of the data pertaining to mouse clicks.

The matching module is used to transform the format of the model image, then based on the difference in the number of times the user clicks each section of the webpage, it will divide the model image into different-colored sections.

The matching module is also used to turn the transformed image into a transparent image.

The display module is used to add javascript in the webpage, then through the newly constructed layer, download the transparent image, and display it on top of the webpage.

In one aspect, a system includes:

A data gathering server, used in gathering user mouse click data;

A data analysis server; after the data gathering server has compiled user mouse click data, it will compute the number of times the user accessed each section of the webpage. The sections are divided according to the contents of the page. Then, the data gathering server will match the sections frequently accessed by the user on the webpage, with sites/sections that are similar or related;

A primary website server, used to display the matching results of the data analysis server.

In addition, the system also includes:

A secondary website server, used to capture the user mouse click data, then reports the data back to the data gathering server.

When this patent application is implemented, it will gather data based on user mouse clicks; it will compute the number of times the user accesses a section of the webpage; it will match the sections frequently accessed by the user on the webpage with sites that are similar or related; it will display the match results, and it will display how the user browses the contents of the webpage and directly and clearly show the level of attention the user spends on the contents. In addition, by matching the sections often accessed by the user with the related/similar sites, it will display the user's level of attention to the webpage content in relation to the other contents of the webpage. These are beneficial to the strategic planners of the website, and will enable them to conveniently and accurately develop strategies.

A preferred embodiment uses traditional statistical methods as the basis for implementing the system to monitor the data and constructed model, presenting the inflexible data to the strategic planners in a direct, clear, fast and convenient manner.

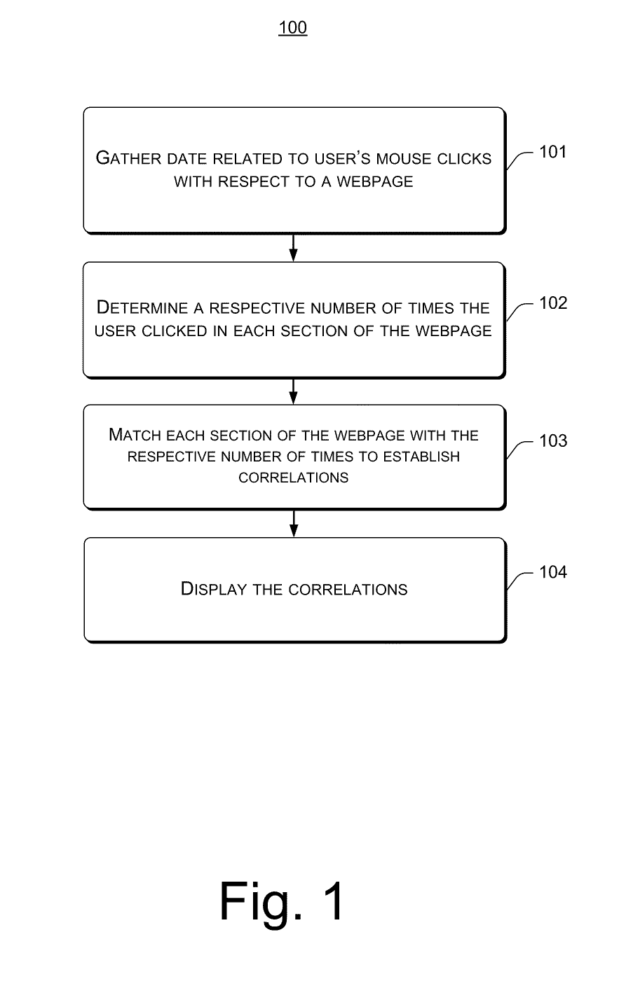

Referring to FIG. 1, the process flow diagram of monitoring users' webpage browsing behaviors includes:

Step 101: Gather the data based on user mouse clicks.

Step 102: Based on the data gathered from the usermouse clicks, it will compute the number of times the user accesses a section of the webpage. There are a number of ways the sections in a website are divided. For example, it can be divided based on the position, or based on the contents. Furthermore, if the sections are divided based on contents, and if the website contains information on news, entertainment, and education, then the website can be divided into news section, entertainment section, and education section. If the webpage is used to display different products, then the webpage can be divided into different sections based on the products. If the webpage contains many links, then each link can be considered as one section.

Step 103: Calculate the number of times the user accessed a section of the webpage, and then match them with sites/sections that are similar or related.

Step 104: Display match results.

The steps in FIG. 1 can be implemented using one entity, and can also be implemented using different entities, depending on the actual requirements. For example, one data gathering server will implement step 101, then that same data gathering server will get the user's mouse click data. A data analysis server will execute steps 102-103, then using the mouse click data gathered from the data gathering server, the same data analysis server will compute the number of times the user accessed a section of the webpage. From there, it will get the frequently accessed sections of the webpage, and match them with sites/sections that are similar or related. Then the primary website server will execute step 104, and it will display the match results from the data analysis server.

The main idea in implementing the four steps mentioned above are described using the data gathering server, data analysis server, and primary website server. However, in various embodiments, different hardware and/or software components may be used. In describing the implementation below, we will use our example to explain.

In a sample implementation, it can capture user mouse click data and the positions clicked, then based on user mouse click it will compute the number of times the user accessed the sections in a webpage. Before executing step 101, it can first capture the data from mouse clicks using another tool, such as another website server (let's call it the secondary website server). This method can have many kinds, one of which is, embedding javascript codes to enable it to capture data. For example, after embedding the javascript codes, when the user clicks onMouseDown, the system will run the additional script in the onMouseDown event to determine the data that the user clicks, and then it will transmit this information to the data gathering server through httpRequest.

In the process, the data from user mouse clicks can include the position clicked, and can also consists of other data that will reflect the specific situation when the user clicks the mouse, such as the related links accessed, screen resolution, user's IP address, cookie and other related data.

Using the secondary website server to capture mouse click data as an example, after the secondary website server has transferred the mouse click data to the data gathering server, the data gathering server can save the data gathered in different formats, so that the data analysis server can conveniently retrieve data for analysis. It can save the data in the sample format below:

X=100Y=200dx=1024dy=768URL=www.alisoft.com

Where X is the distance between the mouse click and the leftmost part of page; Y is the distance between the mouse click and the top of the page; dx is the page's largest width (the page's attribute values can be captured using javascript); dy is the page's highest height (the page's attribute values can be captured using javascript); URL is the address of the mouse click on the webpage.

In the implementation process we can install a daily log document in the data gathering server, where every line in the document records each clicking movement. In the data format above, the “=” sign is part of the format and has no special meaning; one can use “:” to replace it. When analyzed, the above recorded data shows us that the user has click the webpage “URL=www.alisoft.com, the dimension of the webpage (dx=1024 wide, dx=768 high), and the position of the mouse click (X=100, which is the distance from the leftmost part of page; Y=200, which is the distance from top of the page). The values of X and Y are recorded from the actual mouse click position, and the multiple of X over Y is taken from this data.

In one embodiment, when the data analysis server is computing the number of times the user accessed the sections in a webpage, based on the data gathered by the data gathering server, the data analysis server will perform a collective analysis of the data. Further, using the position clicked as a parameter, it will create a dataset for each section. The dataset contains the number of times the accessed each section of the webpage.

When performing a collective analysis, it can use the mouse click frequency or independent user to perform the calculations (similar to the PV and UV in flow rate computation). If mouse click frequency is used to compute every mouse click action, then it will count the number of times the user clicks the mouse; if computation is based on independent user, then regardless of the number of times the user clicks the mouse, the tool will only count it once, similar to doing a head count. When implementing it, the user can choose the calculation script they want to generate. Using the independent user method will add a mechanism for decision-making. This mechanism can use the user's IP address to decide what cookie to use.

If, based on the user's IP address, cookie, and the position parameter clicked, the secondary website server ascertains that the user has clicked the related link/section content more than once, then during the process of creating the dataset (for the mouse clicks) it will not record again the user's succeeding access to the related links/sections. If the IP are the same but the cookies are different, then we can say that the users are not the same (this can mean that different users are using the same end user equipment to connect to the internet). If the IP are different, then we can say that the users are not the same.

In a sample implementation, when the data analysis server is creating a dataset for each section of the webpage, based on the mouse click position, the process can include:

Generate a blank image, then go back to the original mouse click position, and using the position clicked as the base, it will match the position clicked in the blank page. A specific example of generating the blank image includes: prepare a PNG format image file, and based on the actual mouse click movements, it will adjust the size of the PNG format document. Taking the above data format as example, dx=1024 page width and dy=768 page height can be used to generate the blank page. After adjusting the size, use JAVA language to decode the document, and recode if necessary. An implementation example of matching the clicked position parameter with the generated blank image can include: analyze the data from mouse clicks, go back to the original mouse click position, then draw the dots on the blank page based on the mouse click position. Using the above data format as example, X=100, which is the distance from the leftmost part of the page, and Y=200, which is the distance from the top of the page, can be used to draw the dots. Before implementation, if there is an established sequence format that records the mouse click data, then the process of analyzing the position parameter clicked will follow the same principle. Eventually, it will use the original data, as preparation for the succeeding model to be constructed;

During the matching process, it will use a predefined component to create a resulting image to mark the user's every mouse click action, until it has finished constructing a model for every section's dataset. Then using the generated blank image as the base, it will construct a model diagram of the data pertaining to mouse clicks. To use a detailed example, there are many ways to draw the user's mouse click position in the blank image, such as: using a predefined component to create a resulting image to mark the user's every mouse click action, the details of which are:

Saving a PNG image that has been drawn with a dot in the server, so every time a new dot will be drawn, it will copy the dot in the corresponding position in the PNG image;

Finally, the model image constructed from the data clicked is a result of mapping the user's mouse click data in the adjusted blank image, and based on position clicked, it will use a predefined component to create the resulting image. The direct result is a blank image with compressed dots (of course, the dots can also be scattered, depending on the actual clicks in the screen)

After computing the user's access frequency, the data analysis server will match the frequently accessed sections, with the related sections/links, and then pass the data to the primary website server for it to display the match results. This patent does not restrict how the match result is displayed—it can be in the form of diagrams, data, or text. For example, it can use data or text to insert each section's access frequency in other related sections; or, using diagrams to display the result, it can:

After the data analysis server has finished constructing the model for the data clicked, it will transform the format of the model's image; then based on the difference in the number of times the user clicked each section of the webpage, it will divide the model image into different-colored sections. Based on the compression level of the clicked areas, the data analysis server will divide the transformed image into different-colored sections. For example, the more an area is compressed, the brighter the color will be. On the other hand, the less compressed areas will have lighter colors. This will be followed by the primary website server, which will display the transformed image.

To be able to more clearly display the visual result of the user's browsing behavior, the data analysis server will change the transformed image into a transparent image.

During implementation, the tool can use JAVA language to decode the image, change the attributes and recode, adjust the size, change the format and color, and change the image into a transparent one. If the image is a PNG format file, the tool can use JavaScript to change it into CSS format, which is easier to execute. To lessen user browsing tasks, the process of changing the transformed image into a transparent image will be done in the servers. The process of changing the image into a transparent one is done for the succeeding steps, where our ultimate goal is to directly upload the transparent image into the website, and thru the transparent results, to be able to see the contents of the website. When displaying the results, we can add javascript in the webpage, then through the new layer, download the transparent image, and display it on top of the webpage.

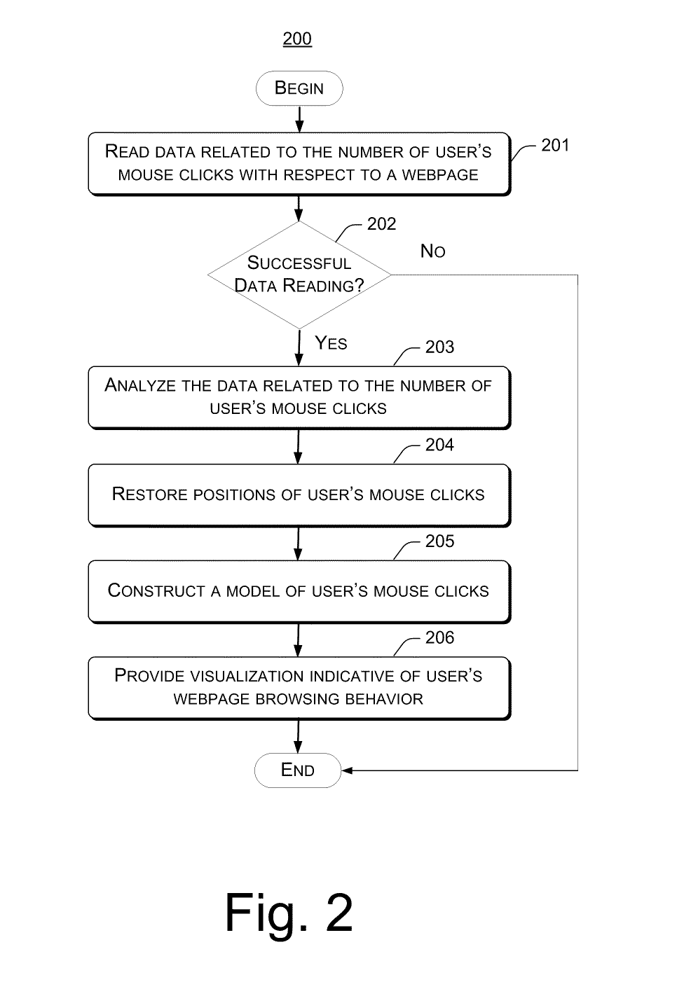

Referring to FIG. 2, in an actual implementation, the whole process of data analysis and model construction (as done by the data analysis server) can include:

Step 201: Retrieve the recorded documents of user's mouse click data;

Step 202: If retrieval is successful, proceed to Step 203, otherwise, end the process;

Step 203: Analyze the recorded document on user's mouse click data;

Step 204: Revert to the original mouse click position;

Step 205: Construct the mouse click model;

Step 206: Generate an image to visually reflect the user's webpage browsing behavior.

On the other hand, during implementation of this patent, we can use Appache server to develop the software to compute the total number of times that the user accessed a webpage, and the number of times each section of the webpage is accessed; we can use the mop_imap module to develop the software to determine the results of accessing each section; in addition, it will match the results of accessing each section with other related sections, and display the match results. This will make the process easier and more convenient.

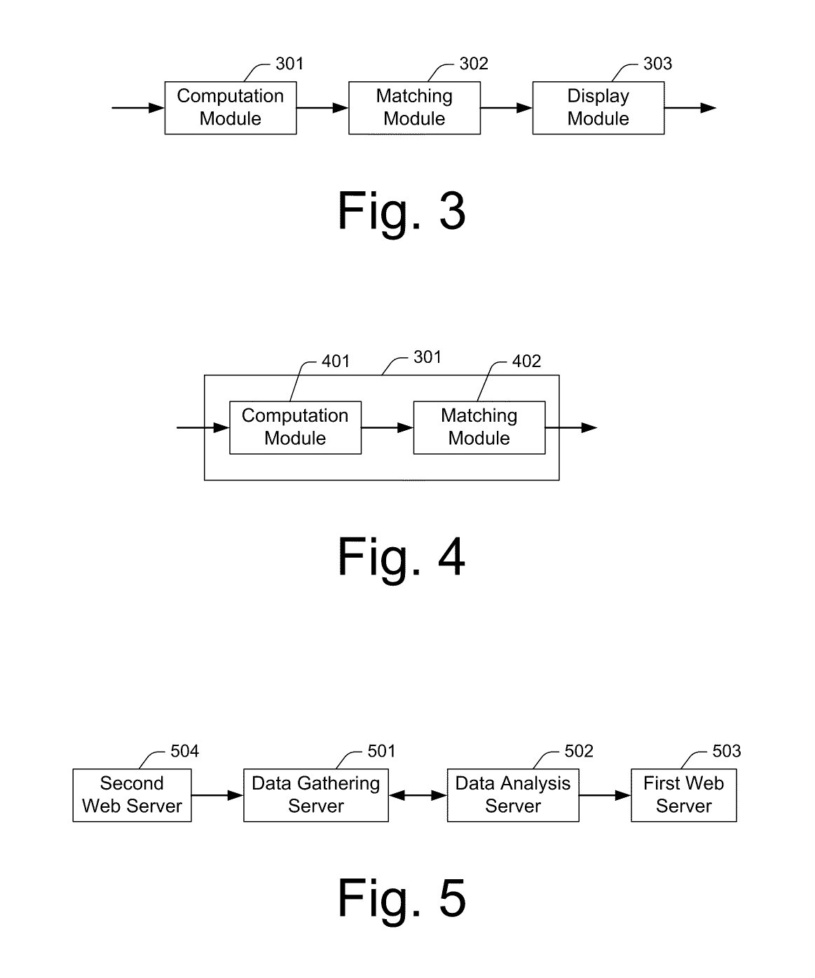

On the basis of similar patents, this patent implementation also proposes a visual mechanism for monitoring user's webpage browsing behavior, where the structure is found in FIG. 3, and can include:

Computation Module 301: used to compute the number of times the user accessed each section of the webpage, based on the user's mouse click data. The sections are divided according to the contents of the webpage;

Matching Module 302: used to match the sections frequently accessed by the user on the webpage, with sites/sections that are similar or related;

Display Module 303: used to display the match results.

Referring to FIG. 4, in an implementation example, the computation module can include:

Acquisition unit 401: in order to get the user's mouse click data;

Calculation Unit 402: used to perform collective analysis of user's mouse click data. Using the position clicked as a parameter, it will create a dataset for each section, which includes the number of times the user accessed each section.

In a sample implementation, the calculation unit can also be used in the following:

ascertain that the user has repeatedly clicked on a section in the webpage, then during the process of creating the dataset, if the user accessed the related links more than once, it will only record in the dataset the first access to the links.

Generate a blank image, then go back to the original mouse click position, and match it in the blank page;

During the matching process, it will use a predefined component to create a resulting image to mark the user's every mouse click action, until it has finished constructing a model for every section's dataset. Then using the generated blank image as the base, it will construct a model diagram of the data pertaining to mouse clicks.

In a sample implementation, the matching module 302 can also be used to:

During the matching process, it will create a resulting image that will track the user's every mouse click, until it has finished constructing a model for every section's dataset. Then using the generated blank image as the base, it will construct a model image.

Turn the transformed image into a transparent image. In a sample implementation, the display module 303 can also be used to:

Add javascript in the webpage, then through the newly constructed layer, download the transparent image, and display it on top of the webpage.

The mechanism mentioned above is a combination of the functionalities of the data analysis server and the secondary website server, which are used by the visual method for monitoring user's webpage browsing behavior. During implementation, these two tools can be executed using one entity, but it is also possible that more than one entity be used to execute them. To make them easily understandable, the functionalities of the above mechanism can be described in terms of modules and units. Of course, when this patent is implemented, it can execute the functionalities of the modules and units in one or more software and/or hardware.

On the basis of similar patents, this patent implementation also proposes a visual system for monitoring user's webpage browsing behavior, where the structure is found in FIG. 5, and can include:

Data gathering server 501: used to gather the data from user's mouse clicks;

Data analysis server 502: used to compute the number of times the user accessed each section of the webpage, based on the user's mouse click data. The sections are divided according to the contents of the webpage; then match the number of times the user accessed each section of the webpage with other related sections;

Primary website server 503: used to display the match results from data analysis server.

In a sample implementation, FIG. 5 shows that the system can also include:

Secondary website server 504: used to capture the data clicked by the user, and to pass them to the data gathering server.

The primary website server, data gathering server, data analysis server, and secondary website server can be several mutually independent servers, or several functionally different modules and units installed in one server.

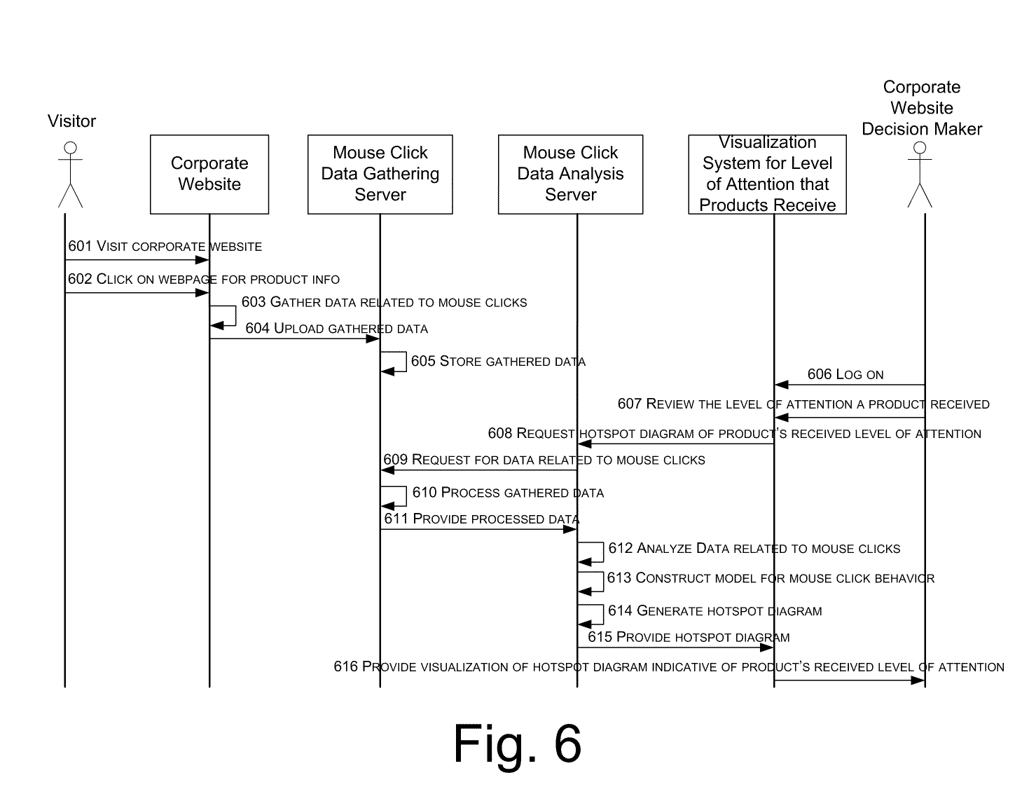

Below is a sample work model of the system for visually monitoring the user's webpage browsing behavior. It is a visual representation of the level of attention that products in a company website receive. Each section in the website is divided according to the different types of products. As shown in FIG. 6, the main operational parts are: visitor (the above-mentioned user), enterprise website (the above-mentioned secondary website server), data gathering server for the user's mouse click data (the above-mentioned data gathering server), data analysis server for the mouse click data (the above-mentioned data analysis server), visual system for monitoring the level of attention that the products receive (the above-mentioned primary website server), and the enterprise website's strategic planner. In this example, the process of monitoring the level of attention that products in an enterprise website receive can include: acquiring the visitor's mouse click data, and uploading the data to the visitor's mouse click data gathering server; data analysis model resulting from the ‘hotspot’ diagram of the product's level of attention; providing the ‘hotspot’ diagram as output to the website's strategic planner.

When the enterprise website's strategic planner wants to know the status of the product's level of attention, he can do so by operating a corresponding module in the system for monitoring the product's level of attention, which will trigger the system to request for a ‘hotspot’ diagram from the mouse click data analysis server. After the mouse click data analysis server has retrieved the visitor's corresponding mouse click data, it will perform a collective analysis, which will create a dataset for each product section, and then create a model on the dataset base, and finally, it will construct the ‘hotspot’ diagram for the product's level of attention.

The detailed steps in the process are:

Step 601: Visitor visits the enterprise website;

Step 602: Visitor clicks on product information;

Step 603: Enterprise website acquires the mouse click data;

Step 604: Enterprise website uploads the acquired mouse click data to the visitor's mouse click data gathering server;

Step 605: Visitor's mouse click data gathering server saves the mouse click data;

Step 606: Enterprise website's strategic planner logs on to the system for monitoring the products' level of attention;

Step 607: enterprise website's strategic planner examines the products' level of attention;

Step 608: The system for monitoring the products' level of attention requests the mouse click data analysis server to produce a ‘hotspot’ diagram for the products' level of attention;

Step 609: The mouse click data analysis server requests the visitor's mouse click data gathering server to provide the mouse click data;

Step 610: The mouse click data gathering server performs a pre-treatment of the saved mouse click data;

Step 611: The mouse click data gathering server passes back the pre-treatment results to the mouse click data analysis server;

Step 612: The mouse click data analysis server decodes the mouse click actions;

Step 613: The mouse click data analysis server finishes the mouse action model;

Step 614: The mouse click data analysis server produces a ‘hotspot’ diagram that reflects the visit's effect on the level of attention that products in an enterprise website receive;

Step 615: The mouse click data analysis server passes back the ‘hotspot’ diagram to the visual system for monitoring the products' level of attention;

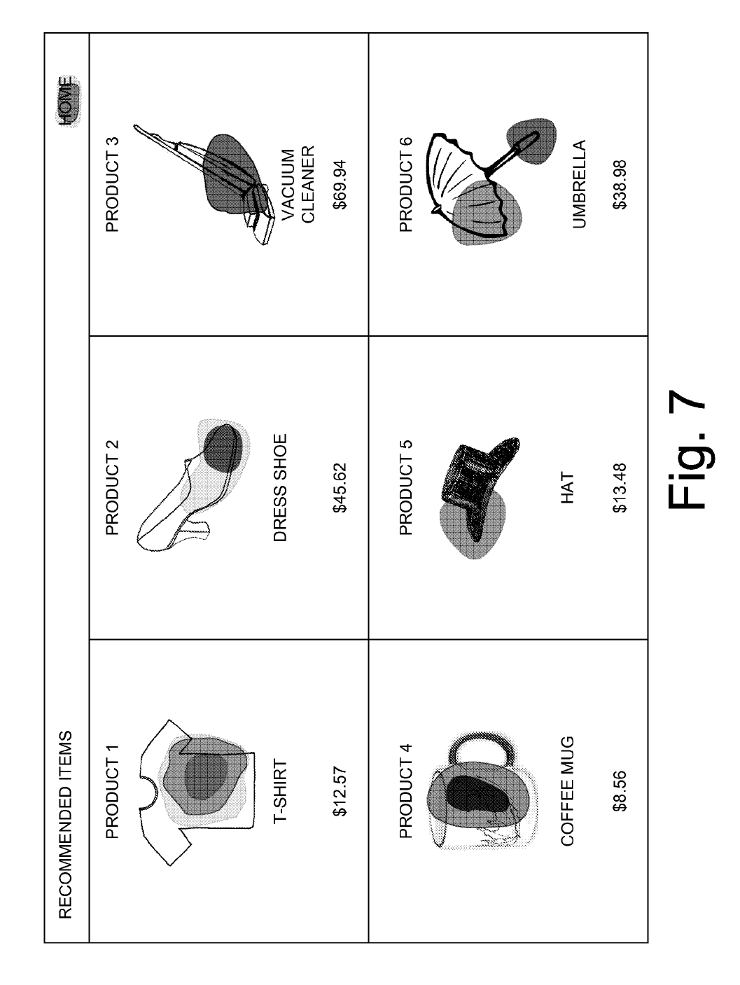

Step 616: The system for monitoring the products' level of attention will present the ‘hotspot’ diagram for the products' level of attention to the company website's strategic planner. While displaying the ‘hotspot’ diagram, it will add javascript codes in the page that displays the product's level of attention, and through the newly constructed layer, it will download the ‘hotspot’ diagram and present it to the strategic planner. Because the ‘hotspot’ diagram has undergone the transparency process, the system will display it on top of the webpage section where the product is displayed. After finishing this step, the system will be able to provide a diagram with the approximate results, the details of which can be found in FIG. 7.

From this, we can see that this patent implementation replicates the visitor's mouse click actions, constructs a corresponding mouse click model, and through a collective analysis of the action models of all the visitors, the system will be able to unambiguously report the products with high attention level and those with low attention level, thus using the visual method to directly and clearly display the visitors' level of attention to the website strategic planner.

On the other hand, the visual system for monitoring the products' level of attention can be further developed to serve as a comprehensive platform for managing the company website's products. Through this platform, the company can conveniently maintain and manage the product information in its own website, and at the same time, combining the two functions in the product deployment will bring huge benefits and convenience.

In implementing this patent, the software for the visitor's mouse click data gathering server and mouse click data analysis server can be developed using Appache server, making the implementation process easier; we can also use Appache's mop_imap module to develop the software, which will allow the modeling and visualization of the section dataset, and the easier creation of the ‘hotspot’ diagram for the attention level. The data gathering server, data analysis server, primary website server, and secondary website server can be several independent servers in terms of physical attributes, or several functionally different modules and units installed in one server.

In summary, in implementing this patent application, it will gather the user's mouse click data; from the data gathered, it will calculate how many times the user accessed an area of the site; from there, it will match the sections frequently accessed with other similar sites/sections, and display the match results. Then it will display the user's webpage browsing behavior through the visual method, thus clearly and directly displaying the user's level of attention to the website's contents. In addition, through matching the sections frequently accessed by the user with other related sites/sections, it will be able to connect the relationship between the user's level of attention on the website's contents with other related contents. This will help the website strategic planner to formulate accurate strategies in relation to the user's webpage browsing behavior.

In this document, enterprise includes companies, organizations, institutions and other legal and non-legal organizations. This patent is not limited to enterprise websites, but can also be used in websites of government agencies, public institutions, associations, and even in personal websites.

Evidently, the proponents of this technology can change or alter the contents of this patent without diverting from the essence and scope of the patent. As such, if changes and alterations to the patents fall under the scope of this request for patent and similar technologies, this patent application intends to include them in its scope.

What is claimed is:

1. A visual method for tracking a user's webpage browsing behavior, the method comprising:
gathering data related to the user's mouse clicks with respect to a webpage;
determining a respective number of times the user clicked in each section of a plurality of sections of the webpage based on the gathered data;
matching each section of the webpage with the respective number of times to establish correlations; and
displaying the correlations.

2. The method as recited in claim 1, wherein gathering data related to the user's mouse clicks comprises:
embedding javascript code in the webpage;
triggering an onMouseDown event based on the user's mouse clicks;
executing additional script in the onMouseDown event to gather the data related to the user's mouse clicks;
transmitting the gathered data through httpRequest.

3. The method as recited in claim 1, wherein determining a respective number of times the user clicked in each section of the plurality of sections of the webpage based on the data gathered comprises:
performing an analysis using the gathered data; and
generating a respective dataset of parameters of mouse click positions that occurred in each section for each of the plurality of sections of the webpage, the respective dataset including the number of times the user clicked in the corresponding section of the webpage.

4. The method as recited in claim 3, wherein performing an analysis using the gathered data comprises:
determining whether the user has clicked in a given section of the webpage multiple times based on a combination of the user's IP address, cookie information, and the parameters of mouse click positions; and
when the user has clicked in the given section of the webpage multiple times, recording one count in the respective dataset for the multiple times that the user has clicked in the given section of the webpage.

5. The method as recited in claim 3, wherein generating a respective dataset of parameters of mouse click positions that occurred in each section for each of the plurality of sections of the webpage comprises:
generating a blank image;
restoring the mouse click positions using the parameters in the respective dataset;
matching the mouse click positions with the blank image;
creating a respective image to mark each of the user's mouse clicks; and
using the generated blank image as the base, constructing a model diagram indicative of the data related to the user's mouse clicks.

6. The method as recited in claim 5, wherein matching each section of the webpage with the respective number of times to establish correlations comprises:
transforming a format of the model diagram to color code the model diagram with various colors based on the number of times the user clicked in each section of the webpage.

7. The method as recited in claim 6, further comprising:
turning the model diagram into a semi-transparent diagram after transforming the format of the model diagram.

8. The method as recited in claim 7, wherein displaying the correlations comprises:
adding javascript in the webpage;
layering the semi-transparent diagram on top of the webpage; and
displaying the resultant webpage.

9. An apparatus that visualizes a user's webpage browsing behavior, the apparatus comprising:
a computation module that computes a number of times the user clicked in each of a plurality of sections of a webpage based on data related to the user's mouse clicks, the webpage divided into the plurality of sections according to contents of the webpage;
a matching module that matches a given section of the webpage with a respective number of times that the user clicked in the given section; and
a display module that displays the matching of the given section of the webpage with a respective number of times that the user clicked in the given section.

10. The apparatus as recited in claim 9, wherein the computation module comprises:
an acquisition unit that gathers the data related to the user's mouse clicks; and
a calculation unit that performs a collective analysis of the data related to the user's mouse clicks to generate a dataset for a given section of the webpage, the dataset including the number of times the user clicked in the given section.

11. The apparatus as recited in claim 10, wherein the calculation unit determines whether the user has clicked in the given section of the webpage multiple times based on a combination of the user's IP address, cookie information, and positions of the user's mouse clicks, and wherein the calculation unit records one count in the dataset when the user has clicked in the given section of the webpage multiple times.

12. The apparatus as recited in claim 10, wherein the calculation unit generates a blank image, matches positions of the user's mouse clicks with the blank image, creates a respective image to mark each of the user's mouse clicks, and constructs a model diagram indicative of the data related to the user's mouse clicks using the generated blank image as the base.

13. The apparatus as recited in claim 12, wherein the matching module transforms a format of the model diagram to color code the model diagram with various colors based on the number of times the user clicked in each section of the webpage.

14. The apparatus as recited in claim 13, wherein the matching module turns the model diagram into a semi-transparent diagram after the format of the model diagram has been transformed.

15. The apparatus as recited in claim 14, wherein the display module adds javascript in the webpage, layers the semi-transparent diagram on top of the webpage, and displays the resultant webpage.

16. A system that visualizes a user's webpage browsing behavior, the system comprising:
a data gathering server that gathers data related to a user's mouse clicks with respect to a webpage;
a data analysis server that computes a number of times the user clicked in each of a plurality of sections of the webpage using the data gathered by the data gathering server, the webpage divided into the plurality of sections according to contents of the webpage, the data gathering server matching a given section of the webpage with a respective number of times that the user clicked in the given section; and
a first web server that displays a matching result of the data analysis server.

17. The system as recited in claim 16, further comprising:
a second web server that captures the data related to the user's mouse clicks and forwards the captured data to the data analysis server.
